(19) United States
(12) Patent Application Publication
(10) Pub. No.: US 2022/0015587 A1
(43) Pub. Date: Jan. 20, 2022

(54) Body Hair Dryer

(71) Applicant: Jered Leshan Gibbs, Porterville, MS (US)

(72) Inventor: Jered Leshan Gibbs, Porterville, MS (US)

(21) Appl. No.: 17/300,488

(22) Filed: Jul. 14, 2021

Related U.S. Application Data
(60) Provisional application No. 63/103,066, filed on Jul. 17, 2020.

(51) Int. Cl. A47K 10/48; A01K 13/00

(52) U.S. Cl. CPC A47K 10/48; A01K 13/001

(57) ABSTRACT

The present invention relates to a hair dryer or hair drying system and process. The body hair dryer is a improve idea, and method for drying body hair in or on humans and certain animals. The preferred hair dryer will be a hair drying unit consisting of an electrical motor and blower with a heating element and thermostat to regulate temperature from hot to warm with attached plastic, nylon, wood or any other non-electrically conductive tubing that extends downward to the floor that has piping or tubing that creates a stationary base that can be stood upon as with the feet of human or located at or near the feet of humans, and the hoofs or paws of some animals which will blow a temperate range of air from hot to warm, and from warm to cool in an upwards direction of the body, while standing vertically, to aid in the hair drying process. The body hair dryer once manufactured will reduce the amount of time normally taken to dry large areas, and amounts of hair, wool or fur, after an individual or animal has become wet by bathing, showering, sweating, swimming or being emersed into water by any means. Until now, after being exposed to, or emersed into water or moisture and being removed from said water or moisture the typical process included the use of a large cloth towel, and in some cases hand-held heated hair dryers to dispel or aid in the dissipation process of most of the water or moisture that is present on the body. These methods typically leave the outer or external body hair in certain areas not completely dry and in some case with excess moisture.

### CROSS-REFERENCE TO RELATED APPLICATION

The application claims the benefit of and priority to U.S. Provisional Patent Application No. 63/103,066 filed on Jul. 17, 2020, which is incorporated herein by reference in its entirety.

### BACKGROUND

Most hair dryers are hand-held devices that are commonly used to dry large areas of hair. The hair dryer is held at a safe distance while a range of temperate air is blown or forced to circulate around, and into the matting of the hair to dry or cause to evaporate most of the wetness that is present after a person or animal has been emersed or exposed to moisture and then removed from said moisture.

Hair dryer which are commonly used to dry body hair on the head comes in a wide variety and designs. They are mainly used for hair drying and hair conditioning, and are applicable to local drying, heating and physical therapy in laboratories, physical therapy rooms, industrial manufacture and art design.

Drying cloths, or shower towels are made of natural materials such as cotton, silk, fur or wool come in a range of different sizes. The sizes of the drying cloth will vary based upon the size of the individual or animal that is intended to be dried. The cloth can be dabbed or blotted along the body of that which has an excess accumulation of moisture but still will not completely remove all moisture thereby living wetness that eventually is covered by cloth or clothing such as undergarments, underwear and undershirts. If the drying process is time consuming, and the body is not completely dried, the remaining or excess moisture once covered by clothing in the case of humans, and fur or wool in the case of animals will lead to irritation and odor.

A bidet is a toilet, commode or basin-like bathroom fixture that is designed to be straddled for bathing and drying the genitals and the posterior parts while a person is seated.

The main reason for body odor is excess moisture that collects and build up in and on the body, particularly in the areas where there are creases, and crevices and exposure to air circulation and flow is extremely limited. These areas, because of the normal body temperature of humans and some animals will be hotter and will lead to a rapid increase in odor especially in the case of perspiration or sweating in the arm pits, buttocks and genital area. If not thoroughly cleaned and dried excess moisture may lead to irritation and in severe cases, infection, due to the build-up and inadequate drying of the body.

There is a need for a new, more effective, less time-consuming body hair drying system and process.

### SUMMARY

According to one aspect of the present invention, there is provided a hair dryer for the body of humans and certain animals that includes an electrical motor, fan, blower, heating element and internal or external thermostatic control, that is connected to tubing or a channel that is attached at the base which is manufactured of plastic or other non-conductive materials that extends downward, and is a part of a tubular base that extends outward to the right and left sides in a half circular shape with created holes, ports or jets that will allow air to escape or be forced in an vertical or upwards direction, targeting the feet, top and bottom, front and back of the ankles, legs, knees, hips, thighs both inner and outer, the genitals, the buttocks, cracks and crevices, the torso area front and back as well as the fingers, wrist, arms, front and back as well as the arm pits and shoulder area, covering the body.

Advantageously, the body hair dryer provides for improved, more effective, and faster drying time when compared with standard hand-held dryers or drying type cloths used as such. Additionally, the body hair dryer will help to reduce irritation and odor that results from excess wetness, and moisture accumulation on the body of humans and certain animals.

### BRIEF DESCRIPTION OF THE DRAWING VIEWS

Preferred features, embodiments and variations of the invention may be discerned from the following detailed description which provides sufficient information for those skilled in the art to perform the invention. The detailed description is not to be regarded as limiting the scope of the preceding summary of the invention in any way. The detailed description will refer to several drawings as follows:

FIG. 1 is a perspective view of the body hair dryer in accordance with an embodiment of the present invention.

FIG. 2 is a side view of the body hair dryer in accordance with an embodiment of the present invention.

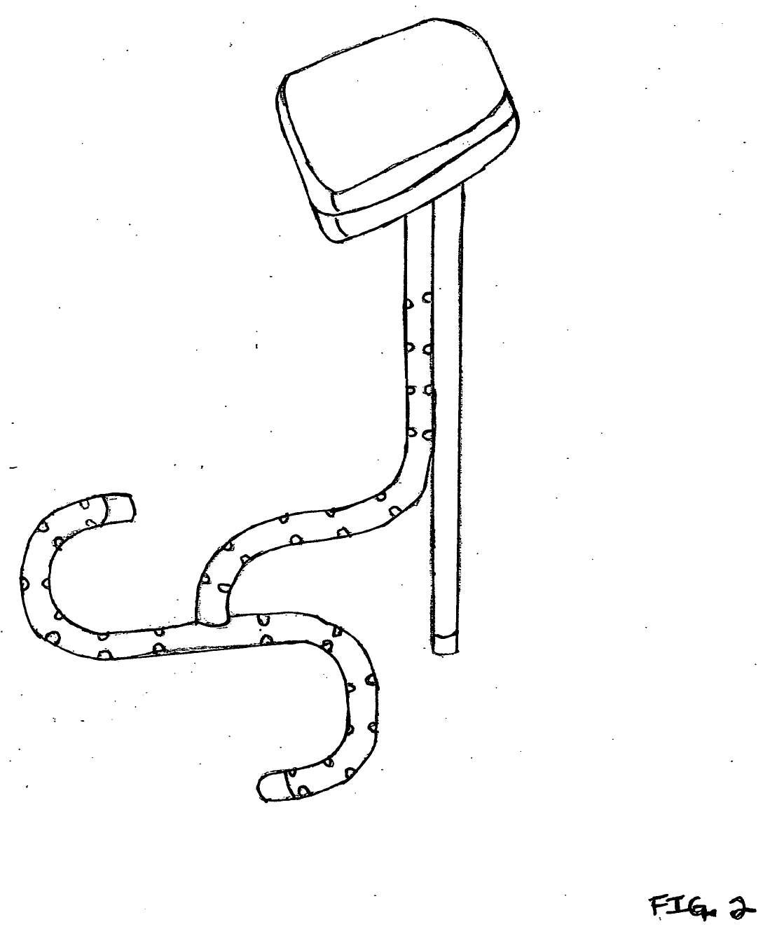

FIG. 3 is a partial exploded view of the body hair dryer.

FIG. 4 is a partial perspective view of the body hair dryer with an animal straddling the base of the invention.

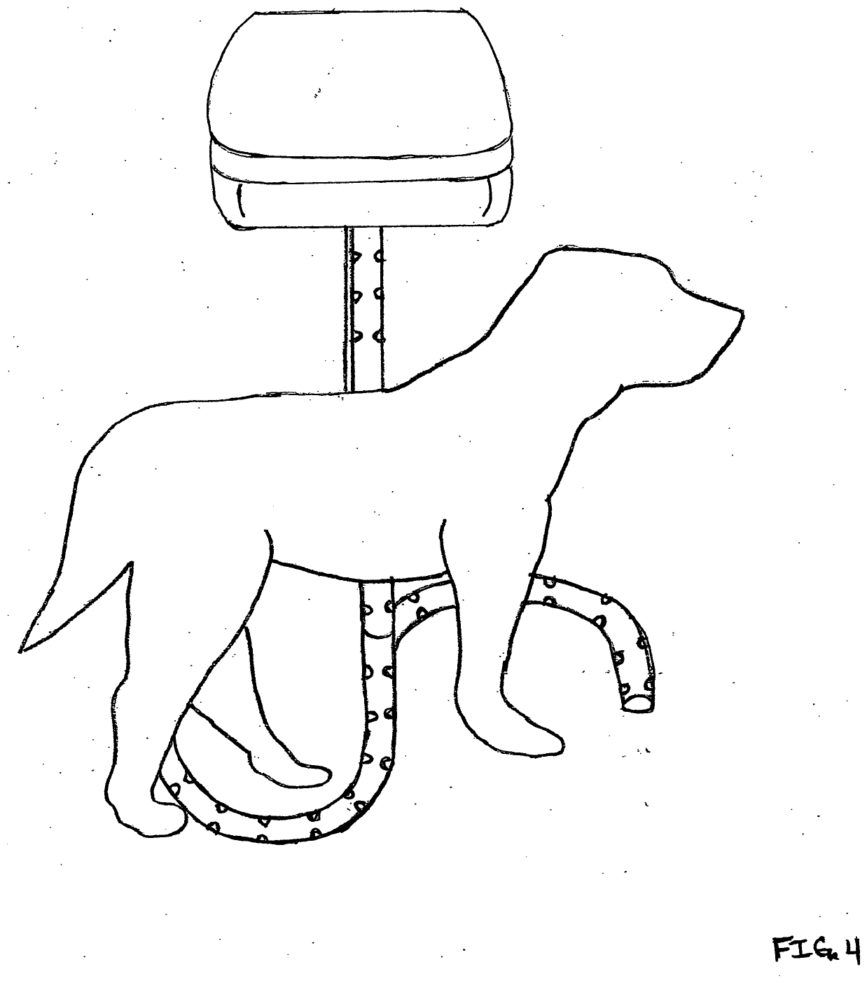

FIG. 5 is a partial side view of the body hair dryer with a partial image of an individual facing away from the front of the invention.

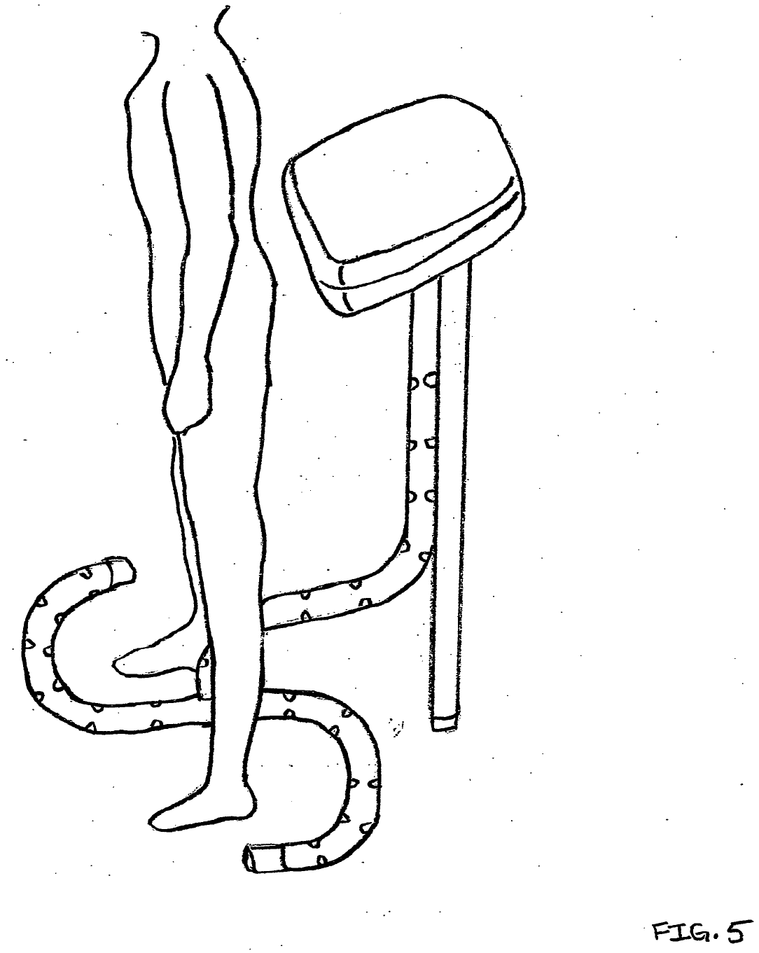

FIG. 6 is a partial side view of the body hair dryer with a partial image of an individual facing the invention.

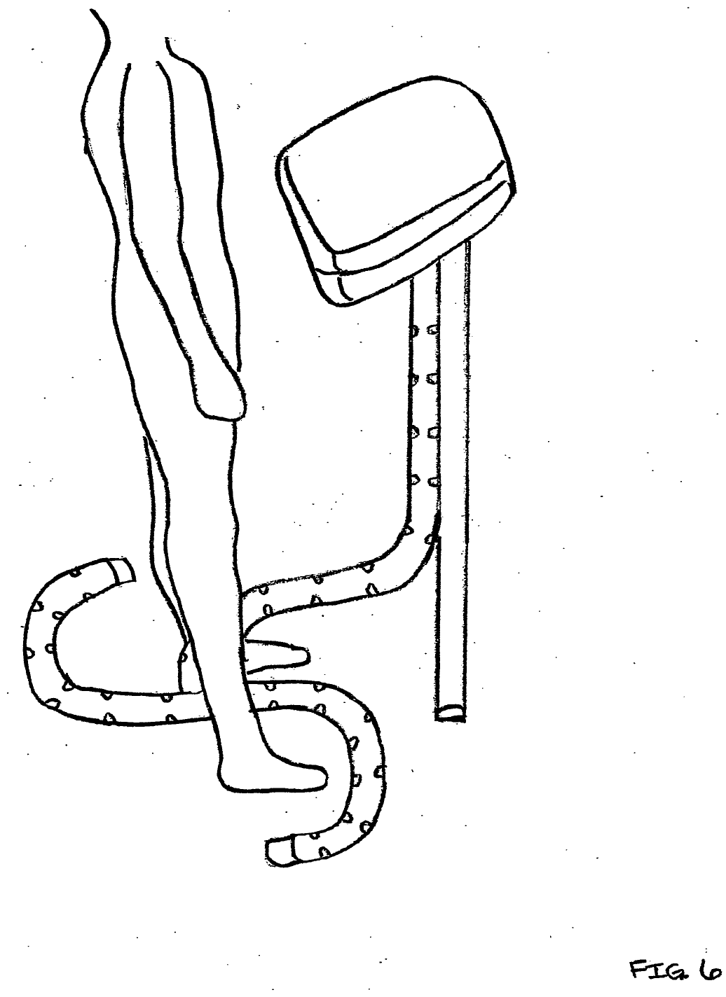

### DETAILED DESCRIPTION OF SELECTED EMBODIMENTS

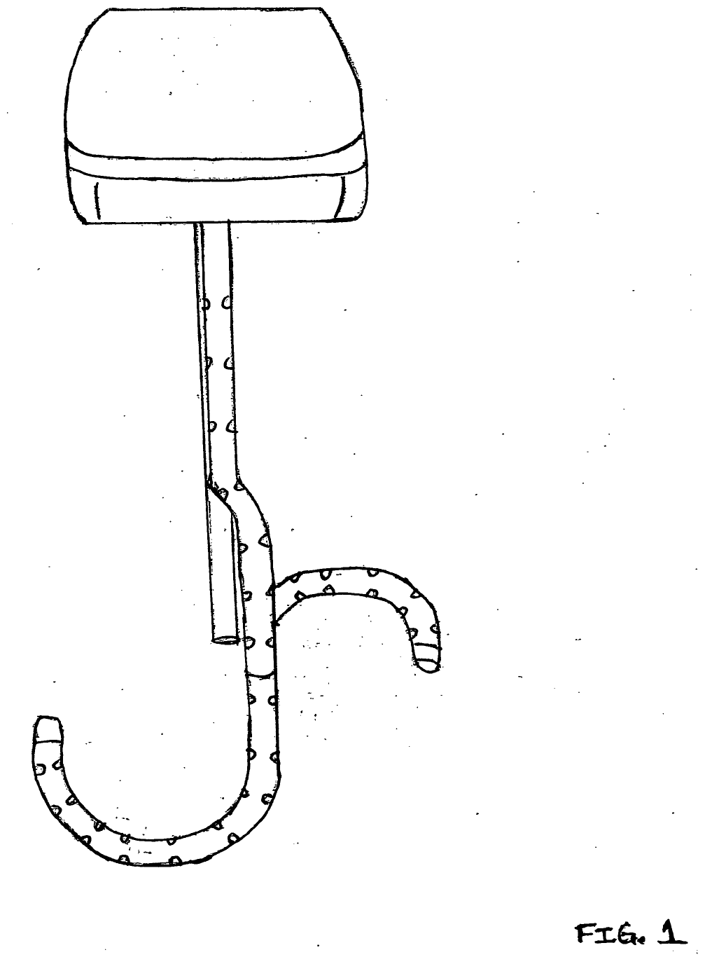

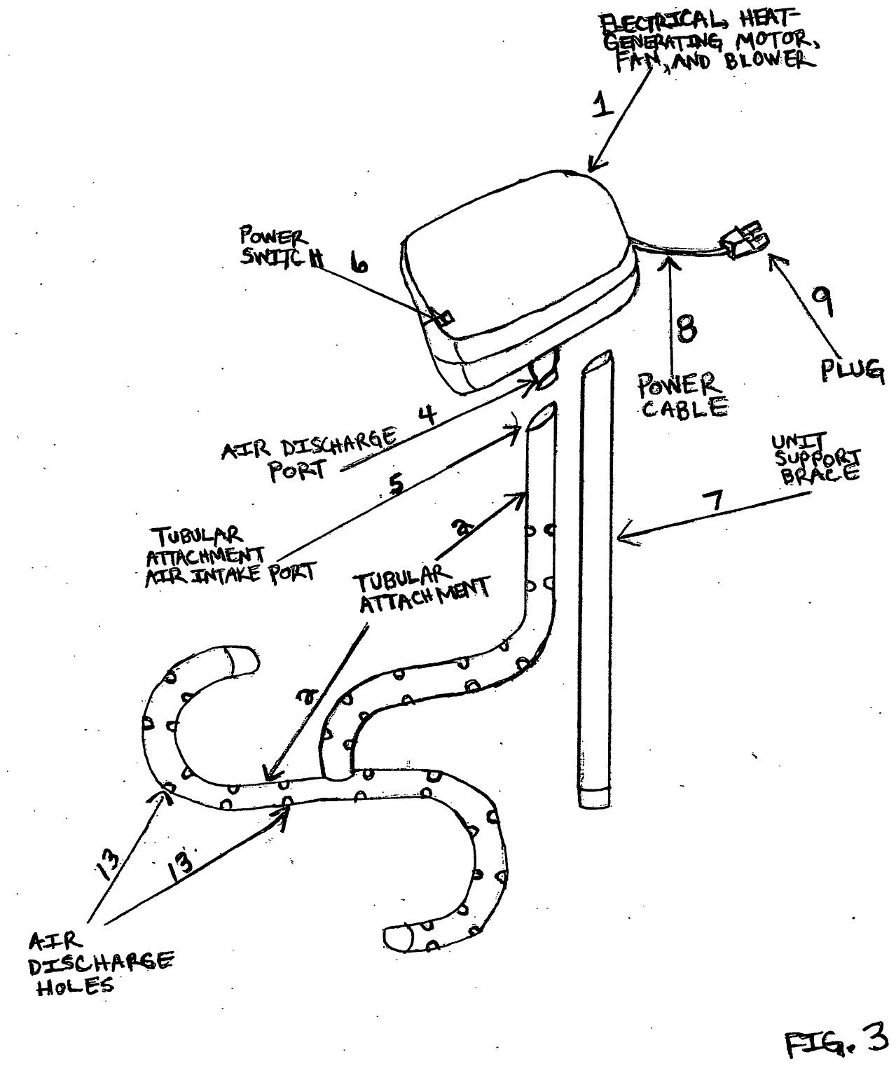

FIGS. 1 and 3 illustrate an embodiment of a body hair dryer. The illustrated embodiments are illustrative only. Body hair dryer FIG. 3 depicts the electrical, heat generating motor, fan and blower 1 enclosed by four side walls, one top, and one bottom wall, which has an opening that will allow for the air discharge port 4 to be joined, connected or inserted into the tubular attachment air intake port 5 which is larger in diameter than the air discharge holes 13. In one embodiment the electrical, heat generating motor, fan and blower 1 and the tubular attachment 2 which may be formed of plastic, nylon, wood or any material that is non-conductive electrically, are formed separately and joined to one another. Unit support brace 7 serves as additional support for the completely assembled body hair dryer, and power switch 6 serves as the power supply control mechanism once connected to an external electrical power supply using a standard 110 or 220-volt power cable 8 and plug 9.

While preferred features, and embodiments have been described, it is to be understood that the embodiments are illustrative only and that the scope of the invention is to be defined solely by the appended claims when accorded a full range of equivalents, numerous variations and modifications naturally occurring to those skilled in the art from a review thereof.

I claim:

1. A body hair dryer comprising:
a tubular attachment;
a heat generating electrical motor which includes a fan, blower, thermostat for heat control, having an external power shut-off switch,
will dry hair, fur and wool by forcefully projecting air from a unit that is enclosed by four side walls, one top, and one bottom wall which will have an opening that will allow for non-electrically conductive tubing and channels to be attached and extended in a downward direction. The air generated by the electrical blow-drying component, would be directed downward and throughout the attached tubing, and then back up, vertically through holes, ports, channels, and jets in the tubing, while being used in the prescribed manner.

2. That the body hair dryer will have a tubular attachment that also serve as the base, for each component of the body hair dryer, that can be stood upon to aid in hair drying by speeding up the moisture evaporation and dissipation process.

3. That the body hair dryer will have a tubular base that can be located at and near the feet of humans to aid in a timelier drying process of human body hair.

4. The body hair dryer of claim 1, wherein the body hair dryer will have a tubular base that can be located at and near the feet, hoofs and paws to aid in a timelier drying process of animal fur and wool.

5. The body hair dryer of claim 1, wherein the body hair dryer can be manufactured using readily available natural, man-made, and recycled materials.

6. The body hair dryer of claim 1, wherein the body hair dryer will reduce the amount of time normally taken to dry body hair verses normal air drying; using a cloth towel, and other natural and man-made products used as such.

7. The body hair dryer of claim 1, wherein the body hair dryer will be more effective at drying larger areas of human hair on the body.

8. The body hair dryer of claim 1, wherein the body hair dryer can be manufactured and designed to blow and project hot air.

9. The body hair dryer of claim 1, wherein the body hair dryer can be manufactured and designed to blow and project warm air.

10. The body hair dryer of claim 1, wherein the body hair dryer can be manufactured and designed to blow and project cold air.

11. The body hair dryer of claim 1, wherein the body hair dryer can be manufactured and designed to blow and project cool air.

12. The body hair dryer of claim 1, wherein the body hair dryer will be more effective at drying the hair near, and in the cracks and crevices of the human body.

13. The body hair dryer of claim 1, wherein the body hair dryer will be more effective at drying the hair near and in cracks and crevices of the under belly and body of certain animals.

14. The body hair dryer of claim 1, wherein the body hair dryer will dry the hair on the top of the head once the head is bowed and when the individual is kneeling.

15. The body hair dryer of claim 1, where in the body hair dryer can be battery powered and operated by a stored energy source.

16. The body hair dryer of claim 1, wherein the body hair dryer will blow room temperature air that is naturally generated from the fan and blower contained within the electrical dryer unit.

17. The body hair dryer of claim 1, wherein the body hair dryer will have at least 1 and up to any number of holes sufficient to allow for air to be expelled and escape through the tubular attachment.

18. The body hair dryer of claim 1, wherein the body hair dryer will have a brace that extends from the base of the electrical dryer component down to the floor to serve as support for the entire unit.

19. The body hair dryer of claim 1, wherein the body hair dryer will be vertically adjustable.

20. The body hair dryer of claim 1, wherein the body hair dryer will be portable.
